(19) United States
(12) Patent Application Publication
(10) Pub. No.: US 2004/0216364 A1
(43) Pub. Date: Nov. 4, 2004

(54) Pest trap monitoring system

(76) Inventor: Joel Norman Joseph Gosselin, Winnipeg (CA)

Correspondence Address: AIKINS PATENT COMPANY, 30TH FLOOR, 360 MAIN STREET, WINNIPEG, MB, R3C 4G1, CA

(21) Appl. No.: 10/408,460

(22) Filed: Apr. 8, 2003

(51) Int. Cl. A01M 23/02

(52) U.S. Cl. 43/61

(57) ABSTRACT

A pest trap monitoring system is disclosed comprising a housing, a holding chamber within the housing, access means for allowing a pest to enter the holding chamber, an actuatable member for actuation by the pest when accessing the holding chamber having an actuated disposition enabling access by the pest to the holding chamber and an unactuated disposition trapping the pest in the holding chamber, sensing means responsive to a transition of the actuatable member from the unactuated disposition to the actuated disposition and for generating a first electronic signal in response thereto, and transmitting means in electronic communication with the sensing means for receiving the first electronic signal from the sensing means and for transmitting a second electronic signal to a receiving means remote from the transmitting means indicating a transition of the actuatable member from the unactuated disposition to the actuated disposition. The system can be used with new pest traps or applied as a retrofit of existing pest traps, and it can be expanded to include a variety of computer-enabled applications.

### BEST TRAP MONITORING SYSTEM

### FIELD OF THE INVENTION

The present invention relates to traps used for pests such as mice and other rodents, and more particularly to monitoring of pest trap activity.

### BACKGROUND OF THE INVENTION

While domestic pest control may require only one trap or a handful of traps situated in appropriate locations, pest control in other contexts sometimes requires numerous and sophisticated traps. For example, pest control in industrial settings such as warehouses may require many traps spaced throughout the building, and checking these many traps can be extremely time-consuming. In addition to concerns over the time spent checking traps, the standard extermination traps are often inappropriate due to the length of time a carcass may have to spend in the trap before removal. For example, U.S. Pat. No. 5,269,091 to Johnson et al. teaches a pest electrocution device, but there are significant health concerns over having the carcass stored in the trap for a potentially considerable length of time before regular checking of the trap.

In response to concerns with extermination traps, a number of live-capture traps have been developed and are used extensively in the industry. While single-catch mouse traps are useful in domestic settings (such as are disclosed in U.S. Pat. Nos. 4,472,904 to Wasielewski and 4,578,893 to Wickenberg), they are often inadequate for industrial settings. Multiple-catch mouse traps (MCMTs) provide live-capture ability and are particularly useful in industrial settings where large numbers of rodents are potentially present. An example of such an MCMT is disclosed in U.S. Pat. No. 6,125,576 to Knuppel, wherein a “paddle-style” trap is taught having a trap compartment for holding at least one mouse. A trigger assembly is engaged by a mouse, which trigger assembly then activates the paddle member to push the mouse into the trap compartment. Another common form of MCMT is the “teeter-style” trap which provides an angled ingress platform that allows the mouse to enter the trap housing, but the platform is depressed by the weight of the mouse to a horizontal disposition that allows the pest to enter the trap compartment, whereupon when the mouse steps off the platform it returns to its angled disposition and blocks the potential exit from the trap compartment.

In live-capture traps such as the MCMT, the mice are not exterminated and food can be left in the trap compartment if desired to sustain the mice until removal. In this way, health concerns over excessive carcass storage are eliminated. However, industrial uses of MCMT devices often require a large number of traps spaced throughout a building or complex of buildings, and regular checking of the traps is still undesirably time-consuming. There are currently no products on the market that effectively deal with both the undesirability of extermination traps and the need to streamline trap-checking procedures. The present invention is concerned with the amelioration of this problem.

### SUMMARY OF THE INVENTION

According to a first aspect of the present invention there is provided a pest trap comprising:

a housing;

a holding chamber within the housing;

access means for allowing a pest to enter the holding chamber;

an actuatable member movably mounted adjacent the holding chamber for actuation by the pest when accessing the holding chamber, the actuatable member having an actuated disposition providing communication between the access means and the holding chamber enabling access by the pest to the holding chamber, and an unactuated disposition blocking communication between the access means and the holding chamber thereby trapping the pest in the holding chamber;

sensing means adjacent the actuating member, the sensing means responsive to a transition of the actuatable member from the unactuated disposition to the actuated disposition and for generating a first electronic signal in response thereto; and

transmitting means in electronic communication with the sensing means for receiving the first electronic signal from the sensing means and for transmitting a second electronic signal to a receiving means remote from the transmitting means indicating a transition of the actuatable member from the unactuated disposition to the actuated disposition.

According to a second aspect of the present invention there is provided a detection means for detecting the presence of a pest in a pest trap of the type comprising:

a housing;

a holding chamber within the housing;

access means for allowing the pest to enter the holding chamber; and

an actuatable member movably mounted adjacent the holding chamber for actuation by the pest when accessing the holding chamber, the actuatable member having an actuated disposition providing communication between the access means and the holding chamber enabling access by the pest to the holding chamber, and an unactuated disposition blocking communication between the access means and the holding chamber thereby trapping the pest in the holding chamber;

the detection means comprising:

sensing means adapted to be mounted adjacent the actuating member, the sensing means responsive to a transition of the actuatable member from the unactuated disposition to the actuated disposition and for generating a first electronic signal in response thereto; and

transmitting means in electronic communication with the sensing means for receiving the first electronic signal from the sensing means and for transmitting a second electronic signal to a receiving means remote from the transmitting means indicating a transition of the actuatable member from the unactuated disposition to the actuated disposition.

According to a third aspect of the present invention there is provided a pest trap monitoring system comprising:

at least one pest trap comprising:

a housing;

a holding chamber within the housing;

access means for allowing a pest to enter the holding chamber;

an actuatable member movably mounted adjacent the holding chamber for actuation by the pest when accessing the holding chamber, the actuatable member having an actuated disposition providing communication between the access means and the holding chamber enabling access by the pest to the holding chamber, and an unactuated disposition blocking communication between the access means and the holding chamber thereby trapping the pest in the holding chamber;

sensing means adjacent the actuating member, the sensing means responsive to a transition of the actuatable member from the unactuated disposition to the actuated disposition and for generating a first electronic signal in response thereto; and

transmitting means in electronic communication with the sensing means for receiving the first electronic signal from the sensing means and for transmitting a second electronic signal indicating a transition of the actuatable member from the unactuated disposition to the actuated disposition; and

receiving means for receiving the second electronic signal from the transmitting means.

In preferred embodiments of the present invention, the access means are at least one tunnel within the housing, the at least one tunnel comprising a first end providing ingress through an external wall of the housing and a second end providing ingress into the holding chamber. In other embodiments of the present invention, the access means are at least one tunnel within the housing, the at least one tunnel comprising a first end providing ingress through a first location on an external wall of the housing, a second end providing ingress through a second location on the external wall of the housing at a point distant from the first location, and a holding chamber ingress means located at a point between the first and second ends and providing selective ingress into the holding chamber. The holding chamber and housing are preferably provided with ventilation holes to allow for live capture of the pest.

In a preferred embodiment of the present invention, the actuatable member comprises an elongate rotatable paddle member that forces the pest into the holding chamber and a trip member for causing rotation of the elongate rotatable paddle member in response to actuation by the pest, the elongate rotatable paddle member having a central axis of rotation with a plurality of paddles extending radially outwardly therefrom. This is commonly known as a “paddle-style” trap. The elongate rotatable paddle in this preferred embodiment has first and second paddles (and most preferably a third paddle) spaced generally equally about the central axis of rotation, whereby upon actuation of the trip member by the pest the elongate rotatable member rotates, causing the first paddle to block a holding chamber ingress means and the second paddle to be positioned to force a second and subsequent pest into the holding chamber. In embodiments where there is a trip member, the sensing means may be for detecting actuation of the trip member, and the transmitting means are then for receiving the first electronic signal from the sensing means indicating that the trip member has been actuated and for transmitting the second electronic signal to a receiving means remote from the transmitting means indicating that the trip member has been actuated.

In other embodiments of the present invention, the actuatable member is a platform that is biased to a first, angled disposition that allows the pest to enter the housing, but depressible by the pest to a second, generally horizontal disposition that allows the pest to enter the holding chamber through a holding chamber ingress means, whereupon when the pest enters the holding chamber and steps off the platform the platform returns to its angled disposition and blocks the holding chamber ingress means. This is commonly known as a “teeter-style” trap.

A variety of sensing means may be employed with the present invention, but the preferred means is a magnetic proximity sensing device comprising a first magnetic member mounted on the actuatable member and a second sensing member mounted on the housing, such that upon actuation of the actuatable member the first magnetic member is temporarily brought into proximity with the second sensing member, the second sensing member thereby detecting the proximity of the first magnetic member and generating the first electronic signal that is transmitted by the sensing means to the transmitting means. Another means is an inductive proximity sensing device comprising a first metallic member mounted on the actuatable member and a second sensing member mounted on the housing, such that upon actuation of the actuatable member the first metallic member is temporarily brought into proximity with the second sensing member, the second sensing member thereby detecting the proximity of the first metallic member and generating the first electronic signal that is transmitted by the sensing means to the transmitting means. The sensing means may also comprise an infra-red sensing device.

In preferred embodiments, the communication between the sensing means and the transmitting means may be either a direct wired electronic communication or a wireless remote electronic communication. As the present invention lends itself to live-capture traps commonly used in the industry, the holding chamber is preferably configured to provide holding space for more than one pest.

In embodiments of the present invention where a plurality of pest traps are used in concert, each pest trap preferably has a distinct electronic identifier that is communicated in the second electronic signal and the receiving means are preferably capable of distinguishing between the distinct electronic identifier of one pest trap and the distinct electronic identifier of another pest trap.

The transmitting means preferably comprise a system power monitor means and the transmitting means for transmitting a third electronic signal to the receiving means remote from the transmitting means indicating a deficiency in system power, and also a reset device for activation after removal from the holding chamber of a pest that has been trapped therein, the transmitting means further for transmitting a fourth electronic signal to the receiving means remote from the transmitting means indicating activation of the reset device.

The receiving means preferably comprise recording means for recording pest trap activity, and interface means for communication with a computer processing device. The pest trap monitoring system preferably comprises a computer processing device in modem communication with the receiving means.

The present invention accordingly provides a live-capture system that can be easily and efficiently monitored, eliminating the need for regular, time-consuming maintenance rounds. Also, as the present invention encompasses embodiments wherein the trap structure itself is being monitored rather than pest movement, it provides a more efficient and accurate reporting of trapping activity, as pest motion reporting may not coincide with actual entrapment. Finally, the present invention may be used to retrofit existing traps without requiring significant alteration of the existing trap structure, as any substantial structural changes may negatively affect trap utility.

A detailed description of exemplary embodiments of the present invention is given in the following. It is to be understood, however, that the invention is not to be construed as limited to these embodiments.

### BRIEF DESCRIPTION OF THE DRAWINGS

In the accompanying drawings, which illustrate exemplary embodiments of the present invention:

FIG. 1 is a perspective view of an embodiment of the present invention employing a “paddle-style” trap, with the front panel removed to show the actuatable member and location of sensing means;

FIG. 2 is a front elevation view of an embodiment of the present invention employing a “teeter-style” trap, with the housing and walls of the access means cut away to show the actuatable members and location of sensing means;

FIG. 3 is a side diagrammatic view of the actuatable member of a “paddle-style” embodiment, showing the paddles and location of the magnetic members; and

FIG. 4 is a schematic view of the pest trap monitoring system as a whole.

### DETAILED DESCRIPTION OF EXEMPLARY EMBODIMENTS

Referring now in detail to the accompanying drawings, there are illustrated exemplary embodiments of the pest trap of the present invention, generally referred to by the numeral 10, and the pest trap monitoring system of the present invention, generally referred to by the numeral 34.

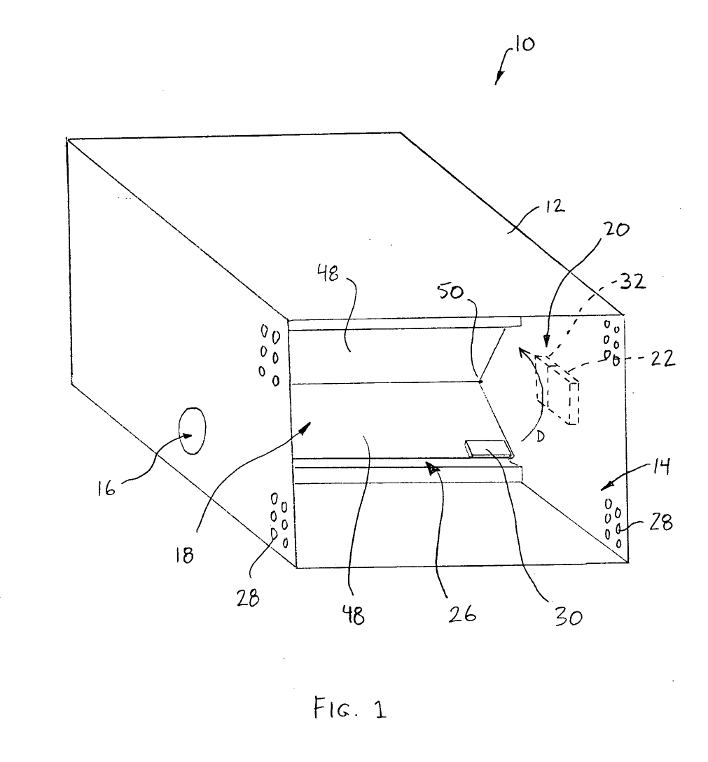

As can be seen particularly in FIG. 1, the pest trap 10 comprises a housing 12, a holding chamber 14 within the housing 12, access means 16 within the housing 12 in communication with the holding chamber 14, an actuatable member 18 movably mounted within the housing 12 which controls access to the holding chamber 14, sensing means 20 adjacent the actuatable member 18, and transmitting means 22 in electronic communication with the sensing means 20. The housing 12 and holding chamber 14 are fitted with ventilation holes 28 to allow captured pests to breathe.

FIG. 1 illustrates a “paddle-style” MCMT wherein the actuatable member 18 comprises an elongate rotatable paddle member having three equally spaced paddles 48 extending radially outwardly therefrom that, upon rotation of the paddle member at pivots 50, force the pest (not shown) out of the access means 16 (a tunnel in this embodiment) and into the holding chamber 14. The direction of rotation is signified in FIG. 1 by the letter D. A trip member (not shown) is located within the access means 16 and causes rotation of the paddle member in response to actuation by the pest. In this embodiment, the holding chamber ingress means 26 are a space that temporarily opens up between the access means 16 and the holding chamber 14 during rotation of the paddle member, but this space is subsequently closed off by the paddle 48 that forced the pest out of the access means 16.

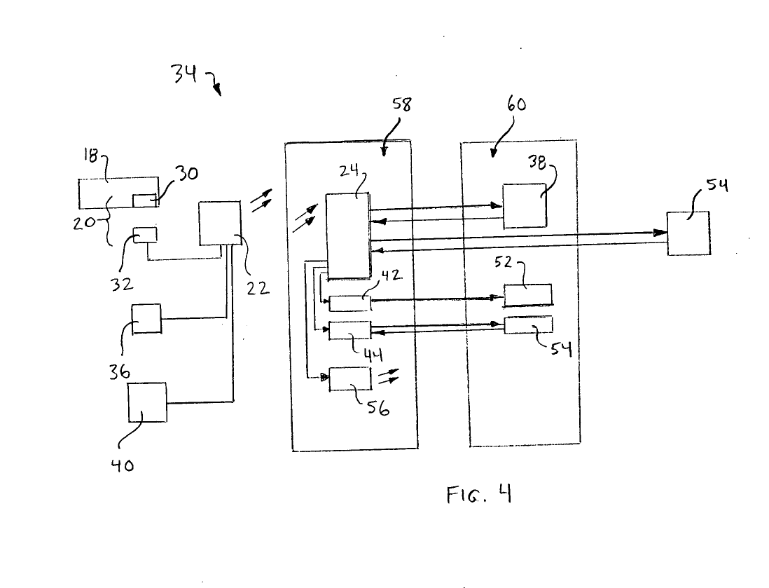

In this “paddle-style” embodiment, each paddle 48 is fitted with a first member 30 and there is a second sensing member 32 mounted on the exterior of the housing 12. The first member 30 is a magnetic member where the sensing means 20 are a magnetic proximity sensing mechanism, with the second sensing member 32 then being a hermetically sealed reed switch that changes state when a magnet is placed close to it. Where the sensing means 20 are an inductive proximity sensing mechanism, the first member 30 is a metallic member and the second sensing member 32 senses the electromagnetic change when the metallic object is placed close to it. The sensing means 20 may also be an infra-red sensing device. While infra-red sensing technology has been used to locate and monitor movement of mice, as in U.S. Pat. Nos. 4,448,150 to Catsimpoolas and 4,902,890 to Biehle, such technology is not currently employed in pest trap activity monitoring. FIG. 3 illustrates in diagrammatic fashion the preferred spacing of the paddles 48 and location of the first members 30. In yet another embodiment (not shown) based on the “paddle-style” MCMT, the first member 30 could be located on the trip member itself, with the second sensing member 32 positioned adjacent the trip member; this would again serve the purpose of providing an indication that the pest trap 10 had been activated.

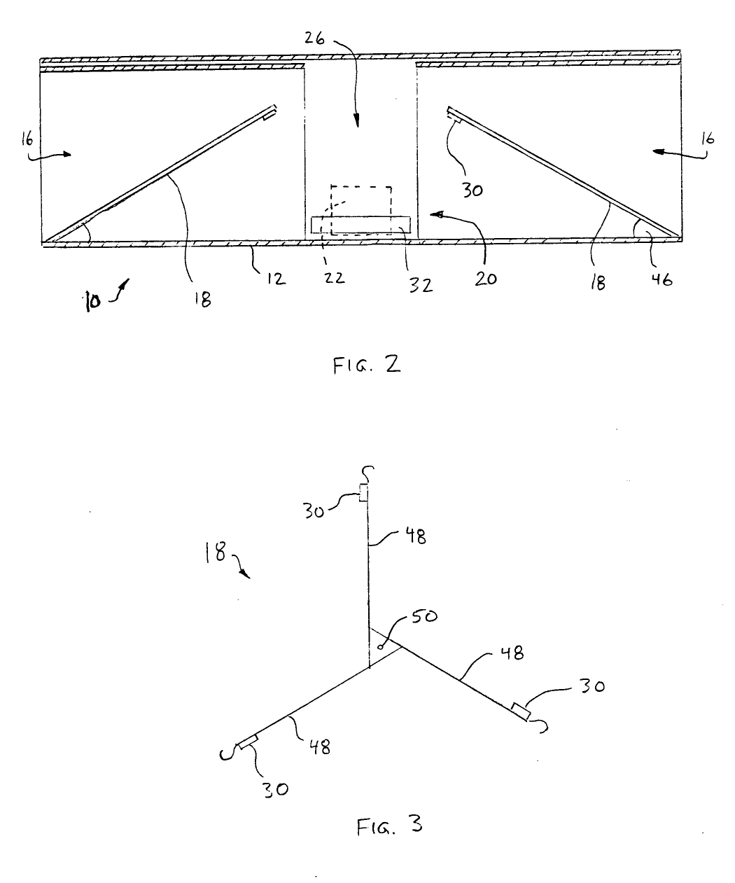

FIG. 2 illustrates a front view of a “teeter-style” pest trap 10, another commonly used trapping device, with the housing 12 and walls of the access means 16 cut away to show the actuatable members 18 and location of the sensing means 20. FIG. 2 illustrates a rear area of the pest trap 10, with the forward holding chamber 14 cut away. The access means 16 in this embodiment are two tunnels that open into a space that defines the holding chamber ingress means 26. The actuatable member 18 in this embodiment is a platform that is biased to a first, angled disposition by biasing means 46 (for example, a spring mechanism) that allows the pest to enter the housing 12, but depressible by the weight of the pest to a second, generally horizontal disposition that allows the pest to enter the holding chamber 14 through the holding chamber ingress means 26, whereupon when the pest enters the holding chamber 14 and steps off the platform the platform returns to its angled disposition and blocks access to the access means 16. This embodiment may also incorporate a means (not shown) of blocking the exterior end of the access means 16 once the pest has entered the access means 16 and depressed the platform, thereby forcing the pest to proceed toward the holding chamber ingress means 26.

FIG. 4 provides a schematic illustration of the pest trap monitoring system 34 of the present invention. As set out above, the actuatable member 18 is provided with a first member 30, the second sensing member 32 in selectively close proximity to the first member 30 (the sensing means 20). The second sensing member 32 of the sensing means 20 is in electronic communication with the transmitting means 22, in this embodiment a direct wired relationship but wireless communication could also be employed. The transmitting means 22 are also provided with input regarding system power levels (for example, low battery levels where battery power is employed for the transmitting means 22, or a power failure if using a wall receptacle) by system power monitor means 36, as well as a tamper indication means 40 to indicate maintenance activities by a technician (not shown) or pest trap 10 damage, and all of this information would be capable of being transmitted to the receiving means 24. As the present invention is of utility in contexts where a large number of pest traps 10 are employed, each of which is provided with transmitting means 22, it is preferable to have each transmitting means 22 in wireless communication with a centrally located receiving means 24.

The receiving means 24 illustrated in FIG. 4 is part of a control panel 58 located on-site at the trapping location. The control panel 58 controls the pest trap monitoring system 34 and is designed to control all programming and communications functions. The control panel 58 includes printer interface means 42 and a serial port 44 for use with on-site computer access. Cellular communication means 56 are also included for use if telephone lines are unavailable for communicating information received by the receiving means 24 or if the technician desires to check the pest trap monitoring system 34 remotely by means of cellular telephone communication. The receiving means 24 include means for recording the time, date, and nature of any pest trap 10 activity.

The pest trap monitoring system 34 also includes a site response means 60, which comprises a digital keypad 38 that allows access to pest trap 10 activity data and enables sending input information back to the receiving means 24, a printer 52 in communication with the printer interface means 42 to receive print-out information regarding pest trap 10 activity, and an on-site computer 54 (which may be a portable PC such as a laptop computer) that allows access to pest trap 10 activity data and enables sending input information back to the receiving means 24. The digital keypad 38 may include a reset switch (not shown) for use by a technician after servicing of the pest trap 10. The pest trap monitoring system 34 also includes a home-base computer 54 (provided with all necessary software) in modem communication with the receiving means 24, so that off-site monitoring and control of the pest trap monitoring system 34 can be maintained without any undesirable site attendance.

Having set up the above pest trap monitoring system 34 at a desired trapping location, with the desired number of pest traps 10 spread out throughout the location, the utility of the present invention becomes clear in the following situation. When a pest enters the access means 16 of a pest trap 10, it is live-captured within the holding chamber 14 (the exact nature of this capture mechanism depending on the style of trap being employed). The actuation of the actuatable member 18 is sensed by the sensing means 20, and this information is sent to the transmitting means 22 which forward the information to the receiving means 24 (along with any information from the system power monitor means 36 and the tamper indication means 40). The receiving means 24 then transmit the information to the home-base computer 54 to allow remote monitoring of the pest trap 10 activity. A technician or maintenance person can then be dispatched to the location to remove the pest from the pest trap 10. As each transmitting means 22 can be provided with a distinct electronic identifier, the technician or maintenance person will know exactly which of the numerous pest traps 10 has been activated.

While a particular embodiment of the present invention has been described in the foregoing, it is to be understood that other embodiments are possible within the scope of the invention and are intended to be included herein. It will be clear to any person skilled in the art that modifications of and adjustments to this invention, not shown, are possible without departing from the spirit of the invention as demonstrated through the preferred embodiment. For example, the pest trap monitoring system 34 may include pager or email notification of pest trap 10 activity to improve the efficiency of remote monitoring, and there may be other sensing methods than those set out above that would be capable of detecting pest trap 10 activity and relaying that information to the transmitting means 22. The invention is therefore to be considered limited solely by the scope of the appended claims.

Embodiments of the invention in which an exclusive property or privilege is claimed are defined as follows:

1. A pest trap comprising:
a housing;
a holding chamber within the housing;
access means for allowing a pest to enter the holding chamber;
an actuatable member movably mounted adjacent the holding chamber for actuation by the pest when accessing the holding chamber, the actuatable member having an actuated disposition providing communication between the access means and the holding chamber enabling access by the pest to the holding chamber, and an unactuated disposition blocking communication between the access means and the holding chamber thereby trapping the pest in the holding chamber;
sensing means adjacent the actuating member, the sensing means responsive to a transition of the actuatable member from the unactuated disposition to the actuated disposition and for generating a first electronic signal in response thereto; and
transmitting means in electronic communication with the sensing means for receiving the first electronic signal from the sensing means and for transmitting a second electronic signal to a receiving means remote from the transmitting means indicating a transition of the actuatable member from the unactuated disposition to the actuated disposition.

2. The pest trap of claim 1 wherein the access means are at least one tunnel within the housing, the at least one tunnel comprising a first end providing ingress through an external wall of the housing and a second end providing ingress into the holding chamber.

3. The pest trap of claim 1 wherein the actuatable member comprises an elongate rotatable paddle member that forces the pest into the holding chamber and a trip member for causing rotation of the elongate rotatable paddle member in response to actuation by the pest, the elongate rotatable paddle member having a central axis of rotation with a plurality of paddles extending radially outwardly therefrom.

4. The pest trap of claim 3 wherein the elongate rotatable paddle has first, second, and third paddles spaced generally equally about the central axis of rotation, whereby upon actuation of the trip member by the pest the elongate rotatable member rotates, causing the first paddle to block a holding chamber ingress means and the second paddle to be positioned to force a second and subsequent pest into the holding chamber.

5. The pest trap of claim 3 wherein the sensing means are for detecting actuation of the trip member, and the transmitting means are for receiving the first electronic signal from the sensing means indicating that the trip member has been actuated and for transmitting the second electronic signal to a receiving means remote from the transmitting means indicating that the trip member has been actuated.

6. The pest trap of claim 1 wherein the actuatable member is a platform that is biased to a first, angled disposition that allows the pest to enter the housing, but depressible by the pest to a second, generally horizontal disposition that allows the pest to enter the holding chamber through a holding chamber ingress means, whereupon when the pest enters the holding chamber and steps off the platform the platform returns to its angled disposition and blocks the holding chamber ingress means.

7. The pest trap of claim 1 wherein the sensing means are a magnetic proximity sensing device comprising a first magnetic member mounted on the actuatable member and a second sensing member mounted on the housing, such that upon actuation of the actuatable member the first magnetic member is temporarily brought into proximity with the second sensing member, the second sensing member thereby detecting the proximity of the first magnetic member and generating the first electronic signal that is transmitted by the sensing means to the transmitting means.

8. The pest trap of claim 1 wherein the sensing means are an inductive proximity sensing device comprising a first metallic member mounted on the actuatable member and a second sensing member mounted on the housing, such that upon actuation of the actuatable member the first metallic member is temporarily brought into proximity with the second sensing member, the second sensing member thereby detecting the proximity of the first metallic member and generating the first electronic signal that is transmitted by the sensing means to the transmitting means.

9. The pest trap of claim 1 wherein the sensing means are an infra-red sensing device.

10. A detection means for detecting the presence of a pest in a pest trap of the type comprising:
a housing;
a holding chamber within the housing;
access means for allowing the pest to enter the holding chamber; and
an actuatable member movably mounted adjacent the holding chamber for actuation by the pest when accessing the holding chamber, the actuatable member having an actuated disposition providing communication between the access means and the holding chamber enabling access by the pest to the holding chamber, and an unactuated disposition blocking communication between the access means and the holding chamber thereby trapping the pest in the holding chamber;
the detection means comprising:
sensing means adapted to be mounted adjacent the actuating member, the sensing means responsive to a transition of the actuatable member from the unactuated disposition to the actuated disposition and for generating a first electronic signal in response thereto; and
transmitting means in electronic communication with the sensing means for receiving the first electronic signal from the sensing means and for transmitting a second electronic signal to a receiving means remote from the transmitting means indicating a transition of the actuatable member from the unactuated disposition to the actuated disposition.

11. The detection means of claim 10 wherein the sensing means are a magnetic proximity sensing device comprising a first magnetic member for mounting on the actuatable member and a second sensing member for mounting on the housing, such that upon actuation of the actuatable member the first magnetic member is temporarily brought into proximity with the second sensing member, the second sensing member thereby detecting the proximity of the first magnetic member and generating the first electronic signal that is transmitted by the sensing means to the transmitting means.

12. The detection means of claim 10 wherein the sensing means are an inductive proximity sensing device comprising a first metallic member for mounting on the actuatable member and a second sensing member for mounting on the housing, such that upon actuation of the actuatable member the first metallic member is temporarily brought into proximity with the second sensing member, the second sensing member thereby detecting the proximity of the first metallic member and generating the first electronic signal that is transmitted by the sensing means to the transmitting means.

13. The detection means of claim 10 wherein the sensing means are an infra-red sensing device.

14. A pest trap monitoring system comprising:
at least one pest trap comprising:
a housing;
a holding chamber within the housing;
access means for allowing a pest to enter the holding chamber;
an actuatable member movably mounted adjacent the holding chamber for actuation by the pest when accessing the holding chamber, the actuatable member having an actuated disposition providing communication between the access means and the holding chamber enabling access by the pest to the holding chamber, and an unactuated disposition blocking communication between the access means and the holding chamber thereby trapping the pest in the holding chamber;
sensing means adjacent the actuating member, the sensing means responsive to a transition of the actuatable member from the unactuated disposition to the actuated disposition and for generating a first electronic signal in response thereto; and
transmitting means in electronic communication with the sensing means for receiving the first electronic signal from the sensing means and for transmitting a second electronic signal indicating a transition of the actuatable member from the unactuated disposition to the actuated disposition; and
receiving means for receiving the second electronic signal from the transmitting means.

15. The pest trap monitoring system of claim 14 comprising at least two pest traps, wherein each pest trap has a distinct electronic identifier that is communicated in the second electronic signal and the receiving means are capable of distinguishing between the distinct electronic identifier of one pest trap and the distinct electronic identifier of another pest trap.

16. The pest trap monitoring system of claim 14 wherein the actuatable member comprises a trip member, the sensing means are for detecting actuation of the trip member, and the transmitting means are for receiving the first electronic signal from the sensing means indicating that the trip member has been actuated and for transmitting the second electronic signal to a receiving means remote from the transmitting means indicating that the trip member has been actuated.

17. The pest trap monitoring system of claim 14 wherein the transmitting means comprises a system power monitor means and the transmitting means for transmitting a third electronic signal to the receiving means remote from the transmitting means indicating a deficiency in system power.

18. The pest trap monitoring system of claim 14 wherein the transmitting means comprise a reset device for activation after removal from the holding chamber of a pest that has been trapped therein, the transmitting means further for transmitting a fourth electronic signal to the receiving means remote from the transmitting means indicating activation of the reset device.

19. The pest trap monitoring system of claim 14 wherein the receiving means comprise recording means for recording pest trap activity.

20. The pest trap monitoring system of claim 14 wherein the receiving means comprise interface means for communication with a computer processing device.
